(19) United States
(12) Patent Application Publication
(10) Pub. No.: US 2014/0054983 A1
(43) Pub. Date: Feb. 27, 2014

(54) LINEAR VIBRATOR

(71) Applicant: SAMSUNG ELECTRO-MECHANICS CO., LTD., Gyunggi-do (KR)

(72) Inventors: Dong Su Moon, Gyunggi-do (KR); Kyung Su Park, Gyunggi-do (KR); Jung Taek Hong, Gyunggi-do (KR); Yong Tae Kim, Gyunggi-do (KR)

(73) Assignee: SAMSUNG ELECTRO-MECHANICS CO., LTD., Gyunggi-do (KR)

(21) Appl. No.: 13/659,377

(22) Filed: Oct. 24, 2012

(30) Foreign Application Priority Data
Aug. 24, 2012 (KR) 10-2012-0092958

(51) Int. Cl. H02K 33/02

(52) U.S. Cl. 310/28

(57) ABSTRACT

Disclosed herein is a linear vibrator including a fixing part including a housing having a certain space formed therein and a coil disposed within the housing, a vibration part including magnets disposed to face the coil such that electromagnetic force acts with the coil, weight bodies coupled to the magnets, and a moving case accommodating the magnets and the weight bodies therein, and an elastic member connecting the fixing part to the vibration part.

### CROSS REFERENCE TO RELATED APPLICATION

This application claims the benefit of Korean Patent Application No. 10-2012-0092958, filed on Aug. 24, 2012, entitled “Linear Vibrator”, which is hereby incorporated by reference in its entirety into this application.

### BACKGROUND OF THE INVENTION

1. Technical Field

The present invention relates to a linear vibrator.

2. Description of the Related Art

Various types of linear vibrators are installed in portable electronic devices such as portable phones, game players, portable information terminals, and the like, in order to prevent damage to other people caused by external sound. In particular, such linear vibrators are mounted in portable phones so as to be used as mute incoming signal generators, and according to the recent trend of portable phones which are increasingly reduced in size and thickness, linear vibrators installed therein are also required to be smaller and have high functions.

Currently, a linear vibrator, one of terminating means applied to communication devices such as portable phones, is a component that converts electrical energy into mechanical vibration by using a generation principle of electromagnetic force, which is installed in portable phones to serve for a mute incoming call notification purpose.

Also, as markets of wireless communication and mobile phones are rapidly expanding, mobile communication terminals supporting various functions emerge and components of mobile communication terminals are required to become compact and have high quality, and in this context, linear vibrators are also correspondingly advancing in performance and technique to improve the drawbacks of existing products while obtaining remarkably improved quality.

However, a general linear vibrator has a problem in that vibration components are separated from each other or distorted in generating vibration.

### PRIOR ART DOCUMENT

### Patent Document

(Patent document 1) US2005-0184601 A

### SUMMARY OF THE INVENTION

The present invention has been made in an effort to provide a linear vibrator in which vibration components are neither separated from each other nor distorted in the occurrence of external impact or vibration.

The present invention has also been made in an effort to provide a linear vibrator having enhanced electromagnetic force so as to generate vibration.

According to an embodiment of the present invention, there is provided a linear vibrator including: a fixing part including a housing having a certain space formed therein and a coil disposed within the housing; a vibration part including magnets disposed to face the coil such that electromagnetic force acts with the coil, weight bodies coupled to the magnets, and a moving case accommodating the magnets and the weight bodies therein; and an elastic member connecting the fixing part to the vibration part.

In the linear vibrator according to an embodiment of the present invention, the fixing part may further include a guide shaft having both ends coupled to the housing and having the moving case inserted thereinto, wherein the moving case is moved upon being guided by the guide shaft.

In the linear vibrator according to an embodiment of the present invention, the guide shaft may be horizontally coupled to the housing such that the vibration part horizontally vibrates.

In the linear vibrator according to an embodiment of the present invention, the moving case may further include bearings provided at both ends of the moving case in a horizontal direction and inserted into the guide shaft.

In the linear vibrator according to an embodiment of the present invention, the elastic member may include a plurality of coil springs, and may be positioned at both sides of the moving case with the guide shaft inserted thereinto.

In the linear vibrator according to an embodiment of the present invention, a plurality of magnets may be provided.

In the linear vibrator according to an embodiment of the present invention, the vibration part may further include a yoke installed within the moving case so as to be positioned between the plurality of magnets.

In the linear vibrator according to an embodiment of the present invention, N polarity may be formed in one side portion of each of the plurality of magnets adjacent to the yoke, and S polarity may be formed in the other side portions of the plurality of magnets, respectively.

In the linear vibrator according to an embodiment of the present invention, a plurality of weight bodies may be provided and coupled to both ends of the plurality of magnets.

In the linear vibrator according to an embodiment of the present invention, the moving case may be formed to have a container-like shape to surround the plurality of magnets, the plurality of weight bodies, and the yoke installed therein, overall.

In the linear vibrator according to an embodiment of the present invention, the fixing part may further include a guide shaft having both ends coupled to the housing and having the moving case inserted thereinto, and as the moving case is moved upon being guided by the guide shaft, the vibration part may vibrate, and the plurality of magnets, the yoke, and the weight bodies may be installed in the moving case such that they are inserted into the guide shaft.

In the linear vibrator according to an embodiment of the present invention, N polarity may be formed in one side portion of each of the plurality of magnets adjacent to the yoke, and S polarity may be formed in the other side portions of the plurality of magnets, respectively.

In the linear vibrator according to an embodiment of the present invention, the plurality of magnets and the yoke may be installed in the guide shaft in a length direction of the guide shaft, and the coil may be disposed to face the plurality of magnets and the yoke in a horizontal direction of the guide shaft.

In the linear vibrator according to an embodiment of the present invention, the guide shaft may be horizontally coupled to the housing such that the vibration part horizontally vibrates.

In the linear vibrator according to an embodiment of the present invention, the moving case may further include bearings provided at both ends thereof and inserted into the guide shaft.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a cross-sectional view of a linear vibrator according to an embodiment of the present invention;

FIG. 2 is an exploded perspective view of the linear vibrator according to an embodiment of the present invention; and

FIG. 3 is an exploded perspective view showing a vibration part of the linear vibrator according to an embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like, are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

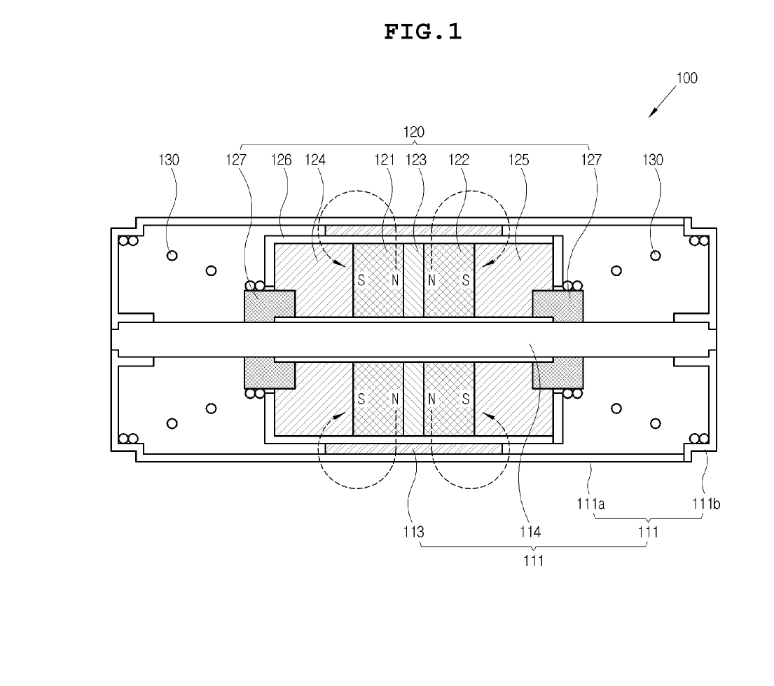

FIG. 1 is a cross-sectional view of a linear vibrator according to an embodiment of the present invention.

Referring to FIG. 1, a linear vibrator 100 according to an embodiment of the present invention includes a fixing part 110, a vibration part 120, and an elastic member 130.

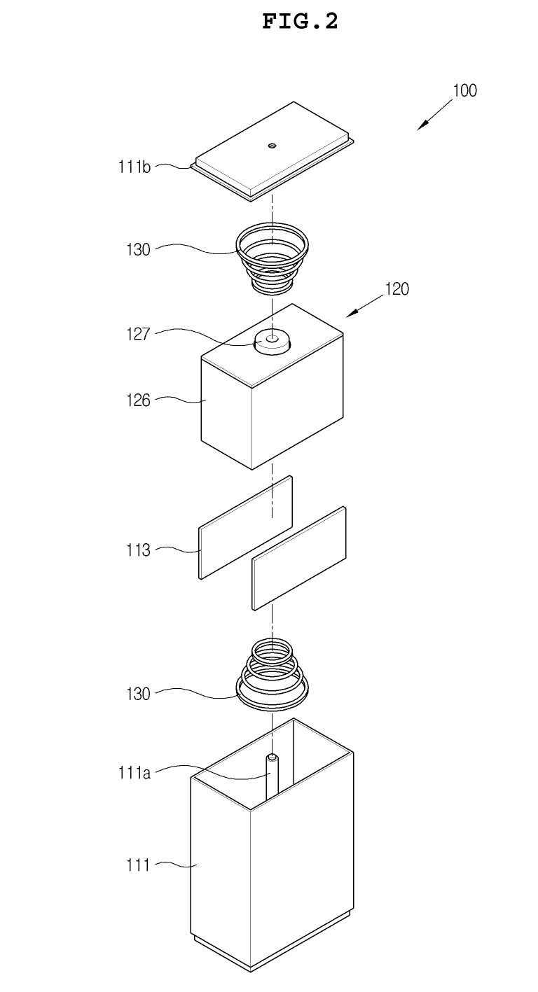

FIG. 2 is an exploded perspective view of the linear vibrator according to an embodiment of the present invention.

Hereinafter, the linear vibrator 100 according to an embodiment of the present invention will be described in detail with reference to FIGS. 1 through 3.

Referring to FIGS. 1 and 2, the fixing part 110 includes a housing 111, a coil 113, and a guide shaft 114.

First, the housing 111 includes a certain space formed therein, in which the vibration part 120 is accommodated, and the coil 113 and the guide shaft 114 are installed at an inner side thereof.

The housing 111 may include a main body 111a and a bracket 111b. Here, the main body 111a has an open upper portion and an accommodation space formed therein, and the bracket 111b is provided to cover an upper portion of the main body 111a.

In addition, the housing 111 has a cylindrical shape. For example, the housing 111 may be formed to have a quadrangular container or cylindrical shape, but the shape of the housing 111 of the present invention is not necessarily limited thereto.

The coil 113 is disposed on an inner lateral surface of the housing 111 and generates electromagnetic force with magnets 121 and 122 upon receiving power. Here, a plurality of coils 113 may be formed and coupled to both sides of the inner surface of the housing 111.

Both ends of the guide shaft 114 are coupled to the housing 111 and movably support the vibration part 120. Here, the guide shaft 114 is horizontally coupled to the housing 111 to support the vibration part 120 such that the vibration part 120 horizontally vibrates, while horizontally reciprocating.

Also, the guide shaft 114 may be formed to have, for example, a circular cylinder shape, but the shape of the guide shaft 114 is not limited thereto.

Meanwhile, the fixing part 110 of the linear vibrator 100 according to an embodiment of the present invention may further include a printed circuit board (PCB) (not shown). Thus, the coil 113 may be electrically connected to the PCB and generate electromagnetic force with the magnets 121 and 122 upon receiving power through the PCB.

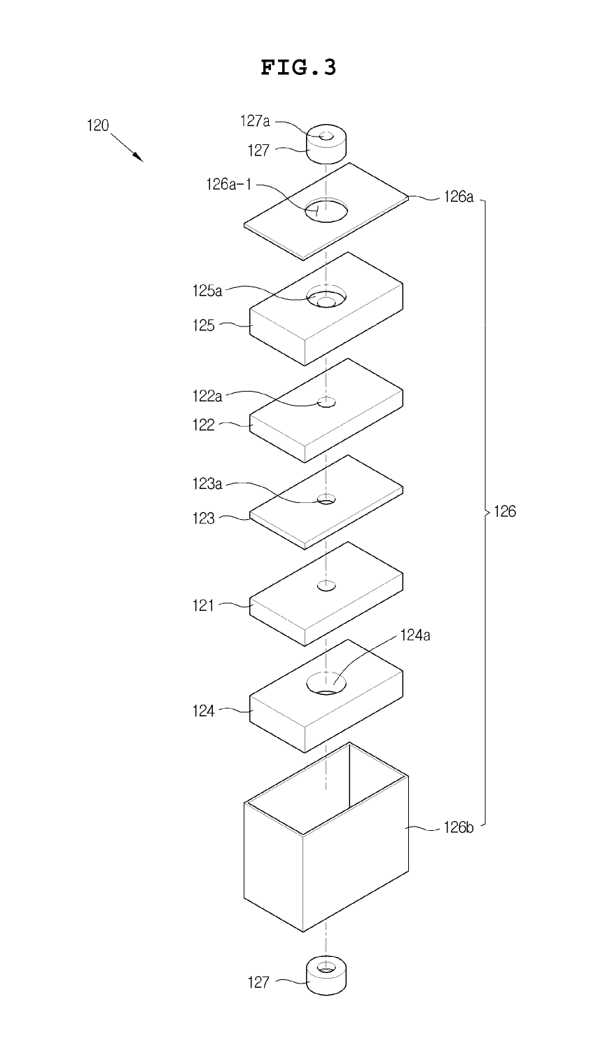

FIG. 3 is an exploded perspective view showing the vibration part of the linear vibrator according to an embodiment of the present invention.

Referring to FIGS. 1 and 3, the vibration part 120 includes the magnets 121 and 122, the weight bodies 124 and 125, a yoke 123, a moving case 126, and a bearing 127.

The magnets 121 and 122 are disposed to face the coil 113 such that electromagnetic force acts with the coil 113. The magnets 121 and 122 are installed in the moving case 126 such that they can be inserted into the guide shaft 114.

A plurality of magnets 121 and 122 may be provided. For example, two magnets 121 and 122 may be provided, but the present invention is not limited thereto.

Meanwhile, a magnet hole 122a is formed at a central portion of the magnets 121 and 122 to allow the guide shaft 114 to be inserted therein.

The yoke 123 is coupled to one surface of each of the magnets 121 and 122, and installed in the moving case 126 such that the yoke 123 can be inserted into the guide shaft 114. Also, when a plurality of magnets 121 and 122 are provided, the yoke 123 may be disposed between the plurality of magnets 121 and 122.

Here, referring to FIG. 1, magnetic polarity of the magnets 121 and 122 is formed in a length direction of the guide shaft 114, and the same magnetic polarity may be formed in a direction in which the plurality of magnets 121 and 122 face. Here, for example, N polarity may be formed in one side portion of each of the plurality of magnets 121 and 122 adjacent to the yoke 123, and S polarity may be formed in the other side portions of the plurality of magnets 121 and 122, respectively.

Here, when a magnetic field of the magnets 121 and 122 is formed in a circle from the N polarity to the S polarity, the magnetic field from the N polarity formed in one side portion of each of the magnets 121 and 122 collides with the yoke 123 to move toward the coil 113.

Accordingly, a stronger magnetic field of the magnets 121 and 122 may be formed toward the coil 113 by the yoke 123. Thus, the magnetic force generated between the magnets 121 and 122 and the coil 113 may be increased to lead to an increase in vibration force of the vibration part 120.

Meanwhile, a yoke hole 123a is formed at a central portion of the yoke 123 to allow the guide shaft 114 to be inserted thereinto.

The weight bodies 124 and 125 are coupled to the other surfaces of the magnets 121 and 122, and installed in the moving case 126 such that they are inserted into the guide shaft 114. In addition, a plurality of weight bodies 124 and 125 may be provided, and when a plurality of magnets 121 and 122 are provided, the weight bodies 124 and 125 may be provided on both ends of the magnets 121 and 122, respectively. Here, the yoke 123 may be positioned at the center, the plurality of magnets 121 and 122 may be positioned on both sides of the yoke 123, with the yoke 123 as the center, respectively, and the plurality of weight bodies 124 and 125 may be positioned on both sides of the plurality of magnets 121 and 122, respectively.

Meanwhile, weight holes 124a and 125a may be formed at the central portions of the weight bodies 124 and 125, respectively, through which the guide shaft 114 may be inserted.

Meanwhile, the plurality of magnets 121 and 122, the yoke 123, and the plurality of weight bodies 124 and 125 may be inserted into the guide shaft 114 in a length direction of the guide shaft 114. Here, the coil 113 may be positioned in a horizontal direction of the guide shaft 114, and may be disposed to face the plurality of magnets 121 and 122 and the yoke 123.

The moving case 126 may include a body 126b having an accommodation space formed therein, one side thereof being open, and a cover 126a. The body 126b accommodates the magnets 121 and 122, the weight bodies 124 and 125, and the yoke 123. The cover 126a covers one side of the body 126b.

The moving case 126 may be inserted into the guide shaft 114, and in addition, the magnets 121 and 122, the weight bodies 124 and 125, and the yoke 123 installed in the moving case 126 may be inserted into the guide shaft 114. Here, a hole is formed on the other central portion of the body 126b and a cover hole 126a-1 is formed at a central portion of the cover 126a, through which the guide shaft 114 may be inserted.

When the moving case 126, having the magnets 121 and 122, the weight bodies 124 and 125, and the yoke 123 installed therein, moves along the guide shaft 114, the magnets 121 and 122, the weight bodies 124 and 125, and the yoke 123 may move together. In addition, since the magnets 121 and 122, the weight bodies 124 and 125, and the yoke 123 are installed in the moving case 126, the vibration part 120 can be easily coupled to the guide shaft 114 and the magnets 121 and 122, the weight bodies 124 and 125, and the yoke 123 can be prevented from being separated by external impact.

Also, the moving case 126 may be formed to have a container-like shape to surround the magnets 121 and 122, the weight bodies 124 and 125, and the yoke 123 overall. Accordingly, the magnets 121 and 122, the weight bodies 124 and 125, and the yoke 123 can be prevented from being distorted due to the moving case 126.

Meanwhile, the moving case 126 may be formed to have, for example, a quadrangular container or cylindrical container shape, but the present invention is not limited thereto. Here, the magnets 121 and 122, the weight bodies 124 and 125, and the yoke 123 may be formed to have a square column or circular cylinder shape with holes formed at the center thereof such that they are accommodated in the moving case 126, but the present invention is not limited thereto.

The bearing 127 is provided in the moving case 126 and inserted into the guide shaft 114. Here, a plurality of bearings 127 may be provided to be disposed at both ends of the moving case 126. Thus, the moving case 126 may easily move along the guide shaft 114.

Meanwhile, a bearing hole 127a may be formed at a central portion of the bearing 127, through which the guide shaft 114 is inserted.

The bearing 127 may be configured as an injection-molded bearing.

Referring to FIGS. 1 and 2, the elastic member 130 elastically connects the housing 111 of the fixing part 110 to the moving case 126 of the vibration part 120.

Here, the elastic member 130, which includes a plurality of coil springs, may be inserted into the guide shaft 114 so as to be positioned at both sides of the moving case 126. Here, both ends of the coil springs may be fixed to an inner surface of the housing 111 and an outer surface of the moving case 126.

TABLE 1

| | Maximum | | Average | 205 Hz Converted | | | |
|---|---|---|---|---|---|---|---|
| | vibration | Current | vibration | vibration | Mechanical noise | Noise band | Noise Thd |
| | amount | consumption | amount | amount | (spec: 27 dB) | (spec: 26 dB) | (spec: 25 dB) |
| In case of | 1.55 G | 73.62 mA | 1.49 G | 1.54 G | 13.27 | 23.27 | 19.28 |
| using one | | | | | | | |
| magnet | | | | | | | |
| In case of | 1.69 G | 73.28 mA | 1.59 G | 1.65 G | 12.70 | 3.35 | 12.50 |
| using two | | | | | | | |
| magnets | | | | | | | |

Table 1 shows a comparison between the use of one magnet and the use of two magnets in the linear vibrator 100 according to an embodiment of the present invention.

Here, it can be seen that, when two magnets are used at both sides of the yoke 123 in the linear vibrator 100 according to an embodiment of the present invention, electromagnetic force is enhanced such that a maximum vibration amount is increased (from 1.55 G to 1.69 G), current consumption is reduced (from 73.62 mA to 73.28 mA), an average vibration amount is increased (from 1.49 G to 1.59 G), a converted vibration amount is increased (from 1.54 G to 1.65 G), and noise touch is reduced.

Also, it can be seen that a remarkable effect of reducing noise band (a different sound appearing as a ‘zing’ in a high frequency band that may be generated according to an assembling structure of each set) and noise Thd (noise basically generated in a structure in which vibration is implemented in contact with rubber when driven) can be obtained.

According to the preferred embodiments of the present invention, since the components of the vibration part are accommodated and installed by using the moving case, the components cannot be separated from each other or distorted due to the occurrence of external impact or vibration, thus providing excellent durability, and since the product is prevented from being defective, maintenance costs can be reduced. Thus, the components of the vibration part can be simply designed in shape and tolerance thereof may be increased, reducing material costs and increasing mass-productivity.

In addition, since the plurality of magnets are positioned at both sides of the yoke and coils are disposed at positions facing the plurality of magnets and the yoke, electromagnetic force can be enhanced and an amount of vibration can be increased.

Moreover, since the guide shaft is horizontally positioned and the vibration part is installed on the guide shaft and horizontally moved along the guide shaft, the vibration part may be designed to have a structure such that it extends in the vibration direction, in comparison to a vertical linear vibrator, increasing an amount of vibration, and although the vibration part has a small weight, a vibration distance thereof can be maximized.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A linear vibrator comprising:
a fixing part including a housing having a certain space formed therein and a coil disposed within the housing;
a vibration part including magnets disposed to face the coil such that electromagnetic force acts with the coil, weight bodies coupled to the magnets, and a moving case accommodating the magnets and the weight bodies therein; and
an elastic member connecting the fixing part to the vibration part.

2. The linear vibrator as set forth in claim 1, wherein the fixing part further includes a guide shaft having both ends coupled to the housing and having the moving case inserted thereinto,
wherein the moving case is moved upon being guided by the guide shaft.

3. The linear vibrator as set forth in claim 2, wherein the guide shaft is horizontally coupled to the housing such that the vibration part horizontally vibrates.

4. The linear vibrator as set forth in claim 2, wherein the moving case further includes bearings provided at both ends of the moving case in a horizontal direction and inserted into the guide shaft.

5. The linear vibrator as set forth in claim 2, wherein the elastic member includes a plurality of coil springs and is positioned at both sides of the moving case with the guide shaft inserted thereinto.

6. The linear vibrator as set forth in claim 1, wherein a plurality of magnets are provided.

7. The linear vibrator as set forth in claim 6, wherein the vibration part further includes a yoke installed within the moving case so as to be positioned between the plurality of magnets.

8. The linear vibrator as set forth in claim 7, wherein N polarity is formed in one side portion of each of the plurality of magnets adjacent to the yoke, and S polarity is formed in the other side portions of the plurality of magnets, respectively.

9. The linear vibrator as set forth in claim 6, wherein a plurality of weight bodies are provided and coupled to both ends of the plurality of magnets.

10. The linear vibrator as set forth in claim 9, wherein the moving case is formed to have a container-like shape to surround the plurality of magnets, the plurality of weight bodies, and the yoke installed therein, overall.

11. The linear vibrator as set forth in claim 7, wherein the fixing part further includes a guide shaft having both ends coupled to the housing and having the moving case inserted thereinto, and as the moving case is moved upon being guided by the guide shaft, the vibration part vibrates, and
the plurality of magnets, the yoke, and the weight bodies are installed in the moving case such that they are inserted into the guide shaft.

12. The linear vibrator as set forth in claim 11, wherein N polarity is formed in one side portion of each of the plurality of magnets adjacent to the yoke, and S polarity is formed in the other side portions of the plurality of magnets, respectively.

13. The linear vibrator as set forth in claim 12, wherein the plurality of magnets and the yoke are installed in the guide shaft in a length direction of the guide shaft, and
the coil is disposed to face the plurality of magnets and the yoke in a horizontal direction of the guide shaft.

14. The linear vibrator as set forth in claim 11, wherein the guide shaft is horizontally coupled to the housing such that the vibration part horizontally vibrates.

15. The linear vibrator as set forth in claim 11, wherein the moving case further includes bearings provided at both ends thereof and inserted into the guide shaft.
